(19) United States
(12) Patent Application Publication
(10) Pub. No.: US 2003/0224933 A1
(43) Pub. Date: Dec. 4, 2003

(54) Catalyst body and method of producing the same

(76) Inventors: Tosiharu Kondo, Toyoake-City (JP); Masakazu Tanaka, Okazaki-City (JP); Hideaki Ueno, Okazaki-shi (JP); Hiromasa Suzuki, Toyota-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/437,887

(22) Filed: May 15, 2003

(30) Foreign Application Priority Data
May 20, 2002 (JP) 2002-144920

(51) Int. Cl. B01J 35/04

(52) U.S. Cl. 502/439; 422/180; 422/177; 502/527.24

(57) ABSTRACT

The present invention can realize a catalyst body which can efficiently achieve a catalytic reaction with a minimum required amount of catalyst and can exhibit high catalytic performance at low cost.

According to the present invention, a catalyst component can be directly supported on the surface of a substrate ceramic and the catalyst component is directly supported on a ceramic carrier 11 having a honeycomb structure which has plural cells 2 partitioned with a cell wall 3. 90% or more of the catalyst component is supported at an outermost layer 4 of the cell wall 3, for example, the portion ranging from the surface to a depth of 30 μm or less, thereby to reduce the amount of the catalyst component which does not contribute to the purification reaction and to reduce the catalyst cost.

### BACKGROUND OF THE INVENTION

1. Field of the Invention

The present invention relates to a catalyst used to purify an exhaust gas of an automobile engine, and to a method of producing the same.

2. Description of the Related Art

To purify a toxic substance discharged from the automobile engine, various catalysts have hitherto been proposed. Regarding a catalyst for purifying an exhaust gas, a coating layer made of a material which has large specific surface area such as γ-alumina is formed on the surface of a carrier which has a honeycomb structure made of cordierite having high resistance against thermal shock, thereby to support a noble metal catalyst such as Pt. The coating layer is formed because cordierite has a small specific surface area. The surface area of the carrier is increased by using a material having a high specific surface area, such as 65 -alumina, thereby to support a required amount of the catalyst component.

However, formation of the coating layer causes an increase in the heat capacity of the carrier, which is undesirable from the point of view of early activation of the catalyst. It also has a problem in that the decrease in the opening area of the cell, as a waste gas flow path, leads to an increase in the pressure loss. Since γ-alumina itself has low heat resistance, the purification performance is drastically lowered by agglomeration of the catalyst component. Therefore, it is necessary to support a large amount of the catalyst component in anticipation of deterioration, resulting in high production cost.

Therefore, a body that can support a required amount of catalyst component without forming a coating layer has been sought. Such a carrier includes, for example, a carrier wherein specific components are dissolved by an acid treatment or a heat treatment, thereby to support catalyst components in vacancies thus formed, however, there arises a problem that the strength is decreased by the acid treatment. Japanese Unexamined Patent Publication (Kokai) No. 2001-310128 proposes a ceramic body obtained by supporting a catalyst in pores comprising oxygen defects, lattice defects and microscopic cracks having a width of 100 nm or less in the crystal lattice. Since pores such as lattice defects are too small to be accounted for in the specific surface area, it is made possible to directly support the catalyst component while maintaining a sufficient strength. Therefore, the resulting catalyst is considered as a possible catalyst for purifying an exhaust gas.

By the way, a multitude of pores that communicate with each other exist in a cordierite honeycomb structure. Therefore, when the catalyst component is supported by a method of immersing in a catalyst solution of the prior art, the catalyst component infiltrates the entire cell wall. However, the catalyst component, which is supported on the surface of the cell wall in contact with an exhaust gas, is believed to exclusively contribute to the reaction, while the catalyst component to be supported in the cell wall hardly contributes. Even when using a ceramic catalyst capable of directly supporting the catalyst component without forming the coating layer, the used catalyst component is substantially not utilized.

### SUMMARY OF THE INVENTION

An object of the present invention is to realize a catalyst body which can efficiently achieve a catalytic reaction with a minimum required amount and can exhibit high catalytic performance at low cost.

According to a first aspect of the invention, the catalyst body comprises a honeycomb structure carrier having plural cells partitioned with a cell wall, capable of supporting a catalyst component directly on the surface of a substrate ceramic, and the catalyst component supported on the carrier, wherein 90% or more of the catalyst component is supported at an outermost layer of the cell wall.

The catalyst body of the present invention provides strong bonding with the catalyst component as compared with the carrier of the prior art because the catalyst component is directly supported on the surface of the substrate ceramic of the carrier. Also the catalyst body is less likely to cause thermal deterioration because no coating layer exists, and thus it is not necessary to support a large quantity of the catalyst component in anticipation of deterioration. Moreover, since 90% or more of the catalyst component was supported on the outermost layer of the cell wall, that is liable to be contacted with a gas to be introduced into the cell, the proportion of the catalyst component that does not contribute to the purification reaction is very small. Therefore, the catalytic reaction can be efficiently achieved with a minimum quantity of the catalyst and high catalyst performance can be exhibited at low cost.

The outermost layer preferably has a thickness of 30 μm or less from the outermost surface of the cell wall. It is considered that the gas introduced into the cell can infiltrate into the portion ranging from the surface to a depth of about 30 μm of the cell wall in the case of a common exhaust gas purifying catalyst for gasoline engine. Thus, the above effect can be obtained if almost all of the catalyst components are supported in the portion near the surface from the above range.

Furthermore, the thickness of the outermost layer is preferably 30% or less of the thickness of the cell wall. It is considered that the catalyst component that contributes to the catalytic reaction is that existing in the portion raging from the surface to a depth of about 30% of the cell wall in case the cell wall is comparatively thick or the gas infiltrates into the portion raging from the surface to a depth of about 30 μm or more of the thickness of the cell wall. Thus, the above effect can be achieved if almost all of the catalyst component is supported in the portion near the surface from the above range.

A porosity of the outermost layer is preferably larger than a porosity of the inner portion. An increase in porosity of the outermost layer makes it possible to increase the surface area and to support the catalyst component with high concentration on the outermost layer.

The porosity of the inner portion of the cell wall is preferably smaller than 35%. In case the porosity of the inner portion of the cell wall is smaller and denser, the catalyst solution hardly infiltrates, and thus it is made possible to support the catalyst component with high concentration on the outermost layer.

A mean pore size of the outermost layer is preferably smaller than a mean pore size of the inner portion. As the total surface area (catalyst supporting area) increases as the pore size decreases, it is made possible to support the catalyst with high concentration on the outermost layer. Specifically, the mean pore size of the outermost layer is preferably 80% or less of the mean pore size of the inner portion.

The carrier is preferably a carrier which has pores or elements capable of supporting the catalyst component directly on the surface of the substrate ceramic. The carrier provides strong bonding with the catalyst component and is less likely to cause deterioration because the catalyst component is directly supported on the pores or elements.

In the present invention, the pores preferably comprise at least one kind selected from the group consisting of defects in the ceramic crystal lattice, microscopic cracks in the ceramic surface and defects in the elements which constitute the ceramic. Specifically, the catalyst body may contain at least one kind among these and the formation of the microscopic pores makes it possible to directly support the catalyst component without reducing the strength.

In preferred aspect of the present invention, the microscopic cracks preferably measure 100 nm or less in width. The width within the above range is preferred to secure sufficient carrier strength.

To make it possible to support the catalyst component, the pores preferably have diameter or width 1000 times the diameter of the catalyst ion to be supported therein, or smaller. In this case, when the density of pores is 1×10¹¹/L or higher, it is made possible to support the catalyst component to the same quantity as in the prior art.

The pores preferably comprise defects formed by substituting one or more elements that constitute the substrate ceramic with a substituting element other than the constituent element, and are capable of supporting the catalyst component directly on the defects. In case the substituting element has a value of valence different from that of the constituent element of the substrate ceramic, lattice defects and/or oxygen defects are generated and it is made possible to directly support the catalyst component in these defects.

Furthermore, the element preferably comprises a substituting element introduced by substituting one or more elements that constitute the substrate ceramic with an element other than the constituent element, and are capable of supporting the catalyst component directly on the substituting element. By directly support the catalyst body in the substituting element, it is made possible to produce a carrier which has a high bonding strength and is less likely to cause thermal deterioration.

Furthermore, the catalyst component is preferably supported on the substituting element by chemical bonding. By chemically bonding the catalyst component with the substituting element, retention properties are improved and the catalyst component is less likely to be agglomerated. As the catalyst component is uniformly dispersed, high performance can be maintained for a long period.

The substituting element is preferably one or more element having d or f orbit in the electron orbits thereof. The element having d or f orbit is effective to improve the bonding strength because it is easily bonded with the catalyst component.

According to a second aspect of the invention, there is provided a method of producing a catalyst body by supporting a catalyst component directly on a honeycomb structure carrier having plural cells partitioned with a cell wall, capable of directly supporting the catalyst component on the surface of a substrate ceramic, said method comprises the steps of immersing the carrier in a water-repellent solution, removing a water-repellent material of an outermost layer of the carrier, and immersing the carrier in a catalyst solution, thereby to support the catalyst component on the outermost layer.

According to the above method, as the water-repellent material of the outermost layer is removed after immersing the carrier in the water-repellent solution, the catalyst component is supported only on the outermost layer and is not supported in the cell wall of coated with the water-repellent material. Therefore, it is made possible to support the catalyst component at a high concentration on the outermost layer.

### BRIEF DESCRIPTION OF THE DRAWINGS

In FIG. l(a) to FIG. l(c), FIG. l(a) is a perspective view showing the overall constitution of a catalyst body of the present invention, and FIG. l(b) and FIG. 1(c) are partially enlarged sectional views schematically showing a state wherein a catalyst component is supported at the outermost layer of a cell wall.

FIG. 2 is a partially enlarged sectional view schematically showing a state wherein a catalyst component is supported on the entire cell wall of a catalyst body.

FIG. 3(a) to FIG. 3(d) are diagrams showing an example of the manufacturing process for a catalyst body of the present invention.

In FIG. 4(a) to FIG. 4(d) which are diagrams for explaining a state of a cell wall in the manufacture of a catalyst body of the present invention, FIG. 4(a), FIG. 4(b), FIG. 4(c) and FIG. 4(d) are diagrams which schematically shows a state before a treatment, a state after immersing in a water-repellent material, a state after hot air treatment, and a state after supporting a catalyst, respectively.

FIG. 5 is a diagram showing a concentration distribution of a catalyst component supported on a cell wall in a catalyst body of the present invention.

FIG. 6 is a graph showing a relation between the catalyst supporting depth and the purification rate.

FIG. 7 is a diagram for explaining details of a process of a hot air treatment for manufacturing a catalyst body of the present invention.

FIG. 8(a) and FIG. 8(b) are diagrams showing another example of the manufacturing process for a catalyst body of the present invention.

FIG. 9 is a sectional view schematically showing a distribution state of pores of a conventional cell wall.

In FIG. 10(a) to FIG. 10(c), FIG. 10(a) is a sectional view showing the overall constitution of DPF to which the present invention is applied, FIG. 10(b) is an enlarged sectional view of the portion A of FIG. 10(a), and FIG. 10(c) is a schematic sectional view of a cell wall.

### DESCRIPTION OF THE PREFERRED EMBODIMENTS

The invention will now be described in detail, below, with reference to the accompanying drawings. Referring to the schematic constitution as shown in FIG. l(a), a catalyst body 1 of the present invention employs, as a catalyst carrier, a honeycomb structure ceramic carrier 11 having plural cells partitioned with a cell wall 3, capable of directly supporting a catalyst component on the surface of a substrate ceramic. The catalyst body 1 comprises the ceramic carrier 11 and the catalyst component supported directly on the ceramic carrier and, as shown in FIG. 1(b), 90% or more of the catalyst component to be supported is supported at an outermost layer 4 of a cell wall 3. The substrate ceramic of the ceramic carrier 11 is not specifically limited, but is preferably a substrate ceramic made from cordierite having a theoretical composition of 2MgO.2Al₂O₃.5SiO₂ as the main component and is advantageous when used under high temperature conditions, as an automobile catalyst. There can also be used ceramics other than cordierite, for example, ceramics containing alumina, spinel, mullite, aluminum titanate, zirconium phosphate, silicon carbide, silicon nitride, zeolite, perovskite, silica-alumina or the like as the main component.

The ceramic carrier 11 has a multitude of pores and/or element capable of directly supporting the catalyst component on the surface of the substrate ceramic so that the catalyst component can be supported directly in the pores or on the element. Specific examples of the pores capable of directly supporting the catalyst component include defects in the ceramic crystal lattice (oxygen defect or lattice defect), microscopic cracks in the ceramic surface and missing defects of the elements which constitute the ceramic. The element is an element introduced by substituting one or more elements that constitute the substrate ceramic with an element other than the constituent element, and is capable of bonding chemically with the catalyst component. The catalyst component is supported by physically or chemically bonding it with the pores or elements and it becomes unnecessary to form a coating layer having a high specific surface area, such as γ-alumina on the ceramic carrier 11. Thus, it is made possible to directly support the catalyst component without causing a change in characteristics of the substrate ceramic or pressure loss.

The pores capable of directly supporting the catalyst component will be described below. As the diameter of the catalyst component ion is usually about 0.1 nm, the diameter or the width of the pores is as small as possible and not larger than 1,000 times (100 nm) the diameter of the ions of the catalyst component to be supported therein, preferably in a range from 1 to 1,000 times (0.1 to 100 nm) in order to ensure the strength of the ceramic. The depth of the pore is preferably a half (0.05 nm) the diameter of the catalyst ion or larger in order to support the ions of the catalyst component. In order to support the catalyst component in a quantity comparable to that of the prior art (1.5 g/L) with the pores of the dimensions described above, density of the pores is 1×10¹¹/L or higher, preferably 1×10¹⁶/L or higher, and more preferably 1×10¹⁷/L or higher.

Among the pores formed in the ceramic surface, the defects in the crystal lattice are classified into an oxygen defect and a lattice defect (metal vacancy and lattice strain). An oxygen defect is caused by the lack of oxygen atoms which constitute the crystal lattice of the ceramic, and this allows it to support the catalyst component in the vacancy left by the missing oxygen. A lattice defect is caused by trapping more oxygen atoms than necessary to form the ceramic crystal lattice, and this allows it to support the catalyst component in the pores formed by the strains in the crystal lattice or the metal vacancies.

A predetermined number, or more, pores can be formed in the ceramic carrier 11, when the cordierite is constituted from cordierite crystal containing at least one defect of at least one kind, of oxygen defect or lattice defect, with density in a unit crystal lattice of cordierite being set to 4×10⁻⁶% or higher, and preferably 4×10⁻⁵% or higher, or alternatively, 4×10⁻⁸ or more, preferably 4×10⁻⁷ or more defects of at least one kind, an oxygen defect or a lattice defect, are included in a unit crystal lattice of cordierite.

The number of oxygen defects and lattice defects is related to the amount of oxygen included in the cordierite, and it is made possible to support the required quantity of a catalyst component by controlling the amount of oxygen to below 47% by weight (oxygen defect) or to over 48% by weight (lattice defect). When the amount of oxygen is decreased to below 47% by weight due to the formation of oxygen defects, the number of oxygen atoms included in the cordierite unit crystal lattice becomes less than 17.2, and the lattice constant for bₒ axis of the cordierite crystal becomes smaller than 16.99. When the amount of oxygen is increased above 48% by weight due to the formation of the lattice defects, number of oxygen atoms included in the cordierite unit crystal lattice becomes larger than 17.6, and the lattice constant for bₒ, axis of the cordierite crystal becomes larger or smaller than 16.99.

Oxygen defects may be formed in the crystal lattice as described in Japanese Patent Application No. 2000-310128, in a process after forming and degreasing, by sintering a material for cordierite which includes a Si source, Al source and Mg source, using a method of substituting a part of at least one constituent element other than oxygen with an element having a value of valence lower than that of the substituted element. In the case of cordierite, since the constituent elements have positive valence, such as Si (4+), Al (3+) and Mg (2+), and substituting these elements with an element of lower value of valence leads to deficiency of positive charge which corresponds to the difference from the substituting element in the value of valence and to the amount of substitution. Thus O (2−) having negative charge is released so as to maintain the electrical neutrality of the crystal lattice, thereby forming the oxygen deficiency.

Lattice defects can be formed by substituting a part of the constituent elements of the ceramic other than oxygen with an element which has a value of valence higher than that of the substituted element. When at least some of the Si, Al and Mg, which are constituent elements of the cordierite, is substituted with an element having a value of valence higher than that of the substituted element, a positive charge which corresponds to the difference from the substituting element in the value of valence and to the amount of substitution becomes redundant, so that a required amount of O (2−) having negative charge is taken in order to maintain the electrical neutrality of the crystal lattice. The oxygen atoms which have been taken into the crystal are an obstacle for the cordierite unit crystal lattice in forming an orderly structure, thus resulting in lattice strain. Alternatively, some of the Si, Al and Mg is released to maintain the electrical neutrality of the crystal lattice, thereby forming vacancies. In this case, sintering is carried out in an air atmosphere so as to ensure sufficient supply of oxygen. As the sizes of these defects are believed to be on the order of several angstroms or smaller, they are not accounted for in the specific surface area measured by ordinary methods such as BET method which uses nitrogen.

Microscopic cracks in the ceramic surface and defects in the elements which constitute the ceramic can also be formed by the method described in Japanese Unexamined Patent Publication (Kokai) No. 2001-310128.

The element capable of directly supporting the catalyst component will be described below. To make it possible to directly support the catalyst component on the ceramic carrier 11, constituent elements of the ceramic (for example Si, Al and Mg in the case of cordierite) are substituted with such an element that has greater force for bonding with the catalyst than the constituent element to be substituted and is capable of supporting the catalyst component by chemical bonding. Specifically, the substituting elements may be those which are different from the constituent elements and have a d or an f orbit in the electron orbits thereof, and preferably have empty orbit in the d or f orbit or have two or more oxidation states. An element which has empty orbit in the d or f orbit has energy level near that of the catalyst being supported, which means a higher tendency to exchange electrons and bond with the catalyst component. An element which has two or more oxidation states also has higher tendency to exchange electrons and provides the same effect.

Elements which have an empty orbit in the d or f orbit include W, Ti, V, Cr, Mn, Fe, Co, Ni, Zr, Mo, Ru, Rh, Ce, Ir, Pt, etc. of which one or more can be used. Among these, W, Ti, V, Cr, Mn, Fe, Co, Mo, Ru, Rh, Ce, Ir and Pt are elements which have two or more oxidation states.

The amount of the substituting element is set within a range from 0.01% to 50%, and preferably in a range from 5 to 20% of the substituted constituent element in terms of the number of atoms. In the case where the substituting element has a value of valence different from that of the constituent element of the substrate ceramic, lattice defects or oxygen defects are generated at the same time depending on the difference in the valence, as described above. However, the defects can be prevented from occurring by using a plurality of substituting elements and setting the sum of oxidation numbers of the substituting elements equal to the sum of oxidation numbers of the substituted constituent elements. Thus the catalyst component may be supported only by chemical bonding with the substituting elements, thereby suppressing the deterioration.

In order to substitute a part of constituent elements of the substrate ceramic of the ceramic carrier 11 with other elements and form pores or introduce elements that can support the catalyst component, a method may be employed such that the material including the constituent element to be substituted is reduced in advance by the amount corresponding to the amount of substitution. This ceramic material, with a predetermined quantity of the material to supply the substituting element added thereto, is mixed and kneaded by an ordinary method, then formed in honeycomb structure having a multitude of cells 2 running in the direction parallel to the gas flow as shown in FIG. 1(a), that is then dried and sintered. In case the substituting element has a value of valence different from that of the constituent element of the substrate ceramic, lattice defects and/or oxygen defects are generated at the same time depending on the difference in the valence. The shape of the cell 2 is not limited to the rectangular cross section shown in FIG. 1(a), and various shapes can be employed. Thickness of the cell walls 3 that separate the cells 2 is usually set to 150 μm or less in the case of an exhaust gas purifying catalyst for gasoline engine, and greater effect of reducing the pressure loss can be expected when the wall is thinner.

Alternatively, a ceramic material made from the material including the constituent element to be substituted, of which the quantity is reduced in advance by the amount corresponding to the amount of substitution, may be mixed, kneaded, formed and dried by an ordinary method, with the resultant preform being immersed in a solution that includes the substituting element. The ceramic carrier 11 with part of constituent elements substituted can also be made by drying and sintering the preform taken out of the solution similarly to the process described above. The latter method causes a significant amount of the substituting element to be deposited on the surface of the preform. As a result, the substitution of element takes place on the surface during sintering, thus making it easier for a solid solution to form. Also, because only the elements that exist on the surface are substituted, influence on the characteristics of the substrate ceramic can be minimized.

The catalyst body 1 of the present invention is obtained in the process described above by depositing desired catalyst component such as three way catalyst, perovskite or NOx catalyst directly on the ceramic carrier 11 of honeycomb structure having pores or elements disposed therein that can directly support the catalyst component on the surface. Specifically, one or more kinds selected from a group consisting of noble metals such as Pt, Rh and Pd, base metals such as Cu and Ni, other metals such as Ce and Li, and oxides thereof may be used as principal catalyst component or auxiliary catalyst component.

The catalyst body 1 of the present invention is characterized in that 90% or more of the catalyst component is supported in the outermost layer 4 of the cell walls 3 that partitions the cells 2 of the honeycomb structure as shown in FIG. 1(b). The outermost layer 4 is a portion where the gas flowing in the cells 2 can infiltrate and the purification reaction by the catalytic component takes place, and has a depth of about 30 μm or less and preferably 25 μm or less from the surface of the cell wall 3. In the case of a common exhaust gas purifying catalyst (with cell walls 100 μm thick or less) for a gasoline engine, for example, a catalyst component that contributes to the catalytic reaction exists in the portion ranging from the surface to a depth of about 30 μm of the cell wall 3. Therefore, sufficient effect can be achieved with a minimum quantity of catalyst, when 90% or more of the catalyst component is supported in this portion. If the thickness of the cell wall 3 is larger than 100 μm, too, a sufficient effect can be achieved by depositing 90% or more of the catalyst component in the outermost layer 4 that is a portion of the partition wall 3 having depth of 30% or less, preferably 25% or less of the thickness of the cell wall 3, thereby reducing the required quantity of catalyst by eliminating the catalyst component that does not contribute to the reaction.

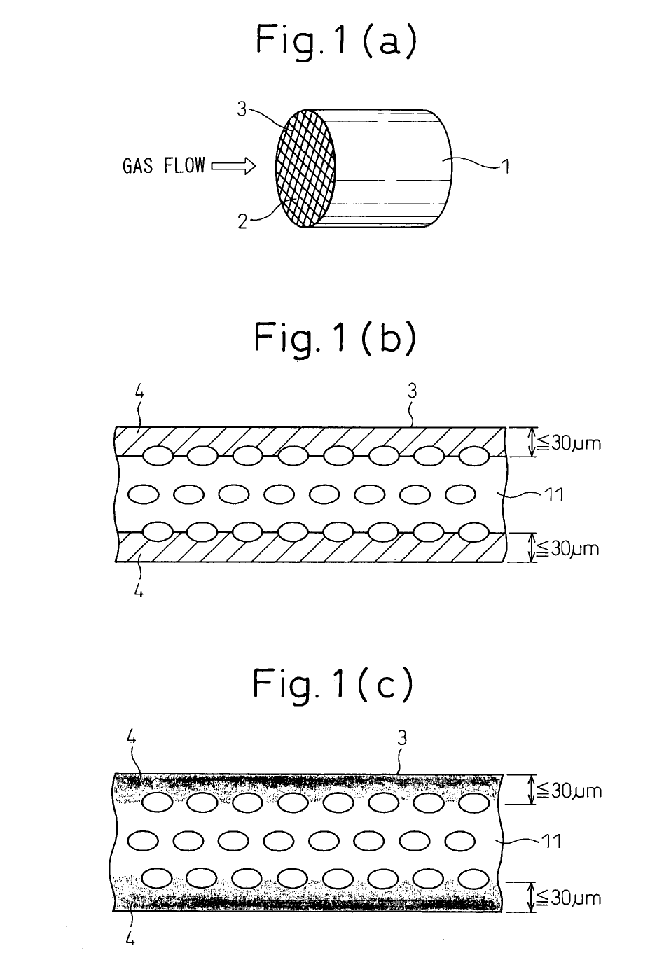

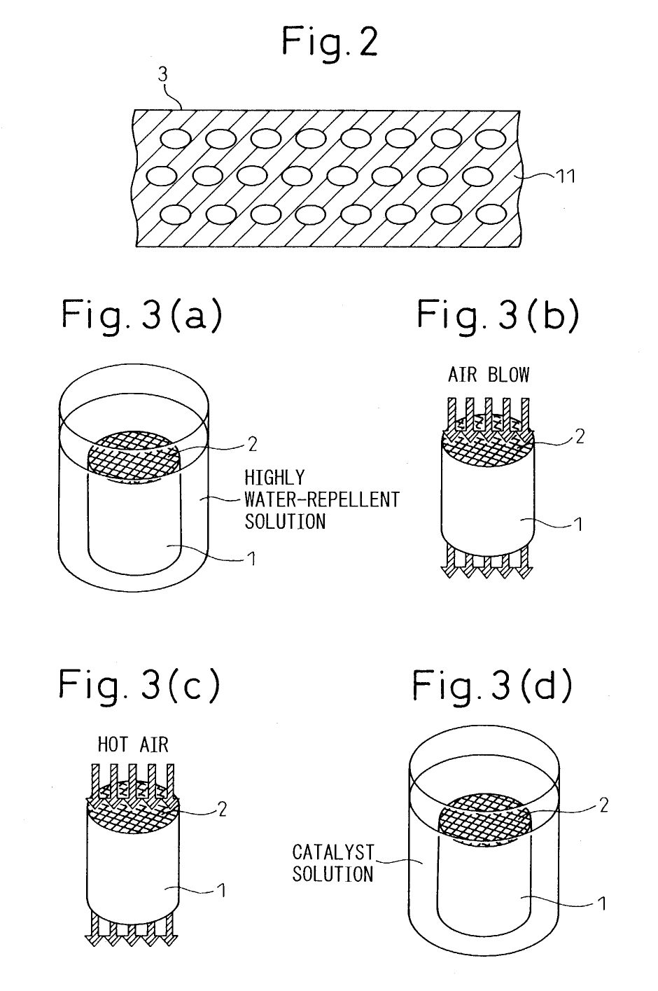

According to the present invention, most of the catalyst component is deposited in the portion of the cell walls 3 near the surface thereof that has higher probability of making contact with the exhaust gas as shown in FIG. 1(b), thereby enabling it to reduce a catalyst component that does not contribute to the reaction and promote the purification reaction by efficiently utilizing the catalyst component that is supported. When the catalyst component is supported throughout the cell walls 3 as shown in FIG. 2, in contrast, the catalyst component located deep inside does not contact the exhaust gas and therefore does not contribute to the reaction. The boundary between the outermost layer 4 where the catalyst component is supported and the inner portion may be either a clear interface between a catalyst-supporting layer and a layer without catalyst as shown in FIG. 1(b), or a transition region where the catalyst concentration decreases gradually as shown in FIG. 1(c) (catalyst concentration is represented by the depth of shading in the drawing). In either case, similar effect can be achieved by depositing 90% or more of the catalyst component in the outermost layer 4.

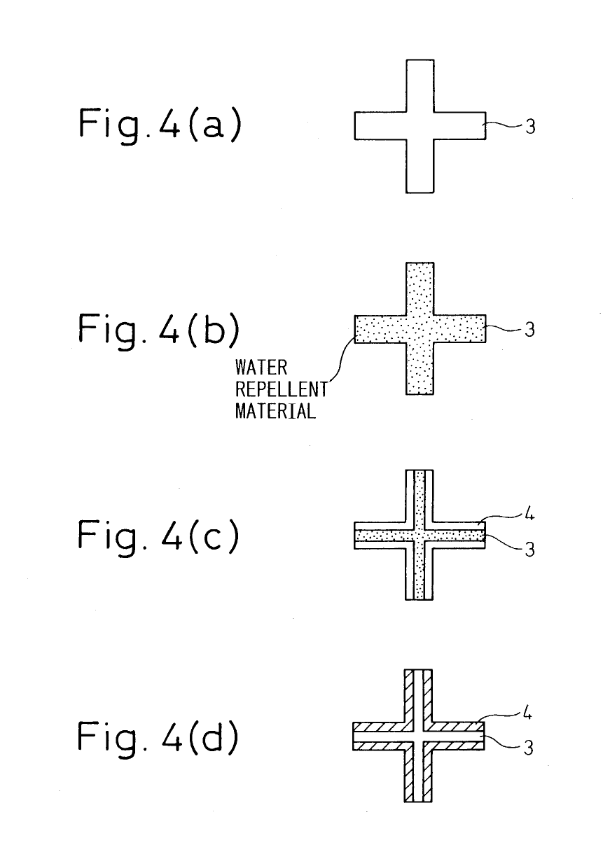

An example of a method for depositing 90% or more of the catalyst component in the outermost layer 4 of the cell walls will be described with reference to FIG. 3(a) to FIG. 3(d) and FIG. 4(a) to FIG. 4(d). First, in a step shown in FIG. 3(a), the ceramic carrier 11 capable of directly supporting the catalyst component that has been produced in the process described above is immersed in a highly water-repellent solution. This turns the cell walls 3 from the untreated state (FIG. 4(a)) to a state wherein the water-repellent material infiltrates throughout the cell walls (FIG. 4(b)). The water-repellent solution is prepared by dissolving a water-repellent material such as silicone oil, methyl cellulose, PVA (polyvinyl alcohol), PVB (polyvinyl butyral), or other resin in a solvent. Beside such a solution, any solution that repels water and alcohol that is used as the solvent for dissolving the catalyst solution to be described later has basically the same effect.

Then, in a second step shown in FIG. 3(b), the ceramic carrier is subject to an air flow (at normal temperature) so as to remove excessive water-repellent solution from the cells 2, and is dried. In a third step shown in FIG. 3(b), hot air is passed through the ceramic carrier 11 so as to melt and remove the water-repellent material from the outermost layer 4 of the cell walls 3, and the cell walls 3 become coated with the water-repellent material except for the outermost layer 4 as shown in FIG. 4(c).

The thickness of the outermost layer 4 (depth of catalyst supporting region) can be controlled by regulating the temperature and velocity of hot air and the duration of treatment process. The hot air temperature is set to a level at which the water-repellent material is melted or higher, usually in a range from 200 to 500° C. The higher the temperature and the longer the processing time, the easier it becomes to remove the water-repellent material. The velocity of the hot air stream is usually set in a range from 0.1 to 10 m/sec. When the velocity is lower than 0.1 m/sec, the temperature difference between the upstream portion of the catalyst support and the downstream portion becomes significant and may cause variations in the depth from which the water-repellent material is removed. Therefore, temperature and velocity of the hot air are determined so as to achieve uniform removal of the water-repellent material from the surface of the cell walls 3 in accordance to the shape of the ceramic carrier 11 and other factors, and the treatment with hot air is carried out until the water-repellent material is removed to the desired depth.

The ceramic carrier 11 is immersed in a solution that includes the catalyst component in a fourth step shown in FIG. 3(d), so that the catalyst component is supported only on the outermost layer 4 from which the water-repellent material has been removed, as shown in FIG. 4(d). The catalyst is then baked and fixed at a temperature from 500 to 600° C., so that the catalyst body 1 of the present invention is obtained. If a plurality of catalyst components are used, the ceramic carrier may be either immersed in a solution that includes the plurality of catalyst components and then baked so as to deposit the catalyst components at the same time, or may be immersed in a plurality of solutions that include different catalyst components successively and then baked. The mean particle size of the catalyst particles is 100 nm or smaller, and is preferably 50 nm or less. Smaller particle size enables it to be densely distributed over the surface of the catalyst support, thus improving the purifying power per unit weight.

FIG. 5 shows the distribution of catalyst component concentration, in the cell walls 3, when the catalyst component is deposited by the method described above on the ceramic carrier 11 made of cordierite honeycomb structure that is capable of directly supporting the catalyst component. The cordierite honeycomb structure was made from a material prepared by reducing the quantities of talc, kaolin, alumina and aluminum hydroxide, that are used to form cordierite, by the amount corresponding to the amount of substitution, then adding tungsten oxide as a compound to supply the substituting element (W) to the material that was mixed in proportion around the theoretical composition of cordierite, to which proper quantities of a binder, a lubricant and water were added and mixed into a paste, forming the paste into honeycomb structure having cell wall thickness of 100 μm, a cell density of 400 cpsi and a diameter of 50 mm, by extrusion molding, and sintering the honeycomb structure in air atmosphere at 1390° C. Methyl cellulose was used as the water-repellent material, and the ceramic carrier 11 was immersed in a water-repellent solution prepared by adding 1% by weight of methyl cellulose to 99% by weight of water, and the ceramic carrier 11 taken out of the solution was subjected to an air flow at normal temperature.

After drying the ceramic carrier 11 at 110° C. for eight hours, the ceramic carrier 11 was exposed to hot air of 300° C. and a velocity of 0.2m/sec for 35 seconds, thereby to remove the water-repellent material from the outermost layer. As the catalyst solution used for depositing the catalyst components of Pt and Rh, an ethanol solution was prepared including 0.051 mol/L of chloroplatinic acid and 0.043 mol/L of rhodium chloride. After immersing the ceramic carrier 11 in this solution for 30 minutes and drying, the ceramic carrier was sintered at 600° C. in air atmosphere so as to have metal Pt and Rh deposited thereon. In order to investigate the condition of supporting the catalyst components on the catalyst body 1 obtained as described above, EPMA analysis was carried out and image processing was conducted on the mapping data to determine the distribution of catalyst concentration with the result shown in FIG. 5.

FIG. 5 indicates that most of the catalyst component is supported in the portion of the catalyst body 1 ranging from the surface thereof to a depth of 30 μm, and substantially no catalyst component exists in the inner portion that is deeper than the portion described above. It was also confirmed, through calculation of the ratio of the catalyst supporting area (S1+S2) to the total area (S) from the concentration distribution, that more than 90% of the catalyst component was supported in the outermost layer 4, that was 30 μm deep from the surface, as follows.

(S1+S2)/S×100=(48+45)/98×100=95.9 (%)

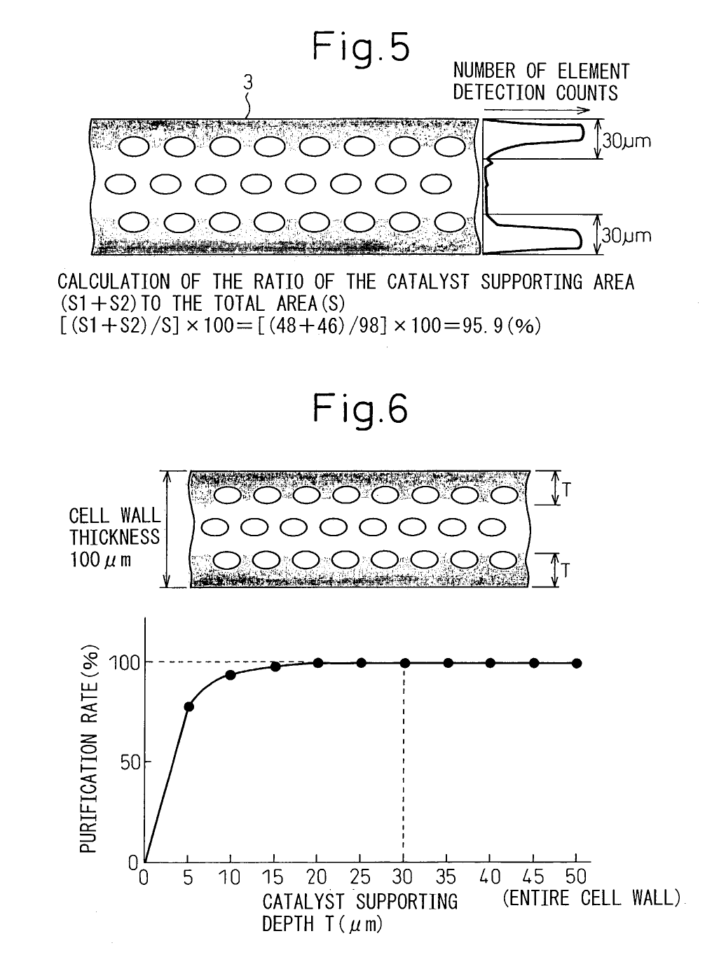

Then various catalyst bodies 1 having different thicknesses (depth of supporting catalyst) T of the outermost layer 4 were made by using the same ceramic carrier 11 (cell wall thickness of 100 μm) while changing the conditions of hot air treatment as shown in Table 1. The purification rate is shown in FIG. 6 as a function of thickness (depth of supporting catalyst) T of the outermost layer 4 of these catalyst bodies 1. Purification performance was tested by introducing a model gas including C₃H₆ into the catalyst body 1 that was heated to a temperature higher than the activation temperature of the catalyst, and measuring the C₃H₆ concentration in the gas at the outlet, with the purification rate calculated as follows.

Purification rate (%)={(C₃H₆ concentration in the gas at the inlet C₃H₆ concentration in the gas at the outlet)/C₃H₆ concentration in the gas at the inlet}×100

TABLE 1

| Catalyst | | | Duration of |
|---|---|---|---|
| supporting | Hot air | Hot air | hot air |
| depth T | temperature | velocity | treatment |
| μm | ° C. | m/sec | sec |
| 5 | 300 | 0.2 | 5 |
| 10 | 300 | 0.2 | 15 |
| 15 | 300 | 0.2 | 20 |
| 20 | 300 | 0.2 | 25 |
| 25 | 300 | 0.2 | 30 |
| 30 | 300 | 0.2 | 35 |
| 35 | 300 | 0.2 | 40 |
| 40 | 300 | 0.2 | 45 |
| 45 | 300 | 0.2 | 50 |
| 50 | No water- | No water- | No water- |
| | repellent | repellent | repellent |
| | solution | solution | solution |

As will be clear from FIG. 6, the purification rate is almost 100% when the catalyst supporting depth T is 20 μm, and it is expected that sufficient level of purification performance could be achieved when the catalyst supporting depth T is in a range from 25 to 30 μm, taking into consideration the variations among the catalyst bodies. This means that the exhaust gas purifying reaction takes place mostly on the catalyst component supported in the portion of the catalyst body 1 ranging from the surface thereof to a depth of 30 μm, and the catalyst component supported in the portion of the catalyst body 1 deeper than 30 μm hardly contributes to the purification of exhaust gas and may be regarded as useless. Similar tests were conducted under such conditions as higher porosity of the cell walls 3, higher possibility of exhaust gas to diffuse and larger thickness of the cell walls 3 (thickness being set to 120 μm, 150 μm and 180 μm). It was verified that an effect similar to that previously mentioned could be achieved under these conditions, provided that the catalyst supporting depth T (thickness of the outermost layer 4) is from around 25% to 30% of the cell wall thickness.

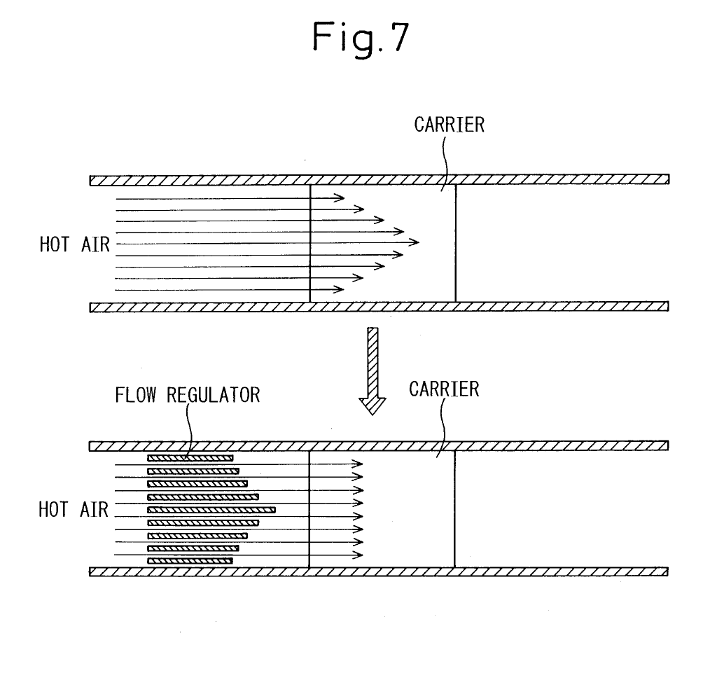

A flow regulator may be used during the hot air treatment as shown in FIG. 7. As shown at the top of FIG. 7, the velocity of the hot air flowing through the ceramic carrier 11 is generally higher at a position nearer to the center of the support. Therefore, the flow regulator is disposed in the upstream of the ceramic carrier 11 as shown at the bottom of FIG. 7 so as to prevent the stream from becoming turbulent and introduce the hot air uniformly into the support by increasing the resistance against the air flow at the center of the flow regulator. For the flow regulator, those known in the prior art may be used, such as a metal honeycomb made by winding a metal corrugated sheet and a metal flat sheet put together in a spiral configuration. Hot air flowing through the ceramic carrier 11 can be controlled by making the stream path length different between the middle and peripheral portions of the honeycomb. With such a configuration, no disparity is produced in the hot air stream through the ceramic carrier 11 so that the hot air treatment is carried out uniformly and, therefore, thickness of the outermost layer 4 wherein the catalyst is supported can be made uniform throughout the catalyst body.

The catalyst body 1 of the present invention, that is made as described above, has the catalyst component directly supported in the pores or on elements without an intervening coat layer and is therefore provides strong bonding without problem of thermal deterioration of the coat layer. Moreover, since more than 90% of the catalyst component is supported in the outermost layer 4 of the cell walls 3 of the ceramic carrier 11, the quantity of the catalyst component located deep inside of the cell walls 3 and does not contribute to the purification reaction can be reduced. As a result, the catalyst body has a smaller heat capacity and lower pressure loss, and can achieve high purification performance by efficiently utilizing the catalyst supported thereon.

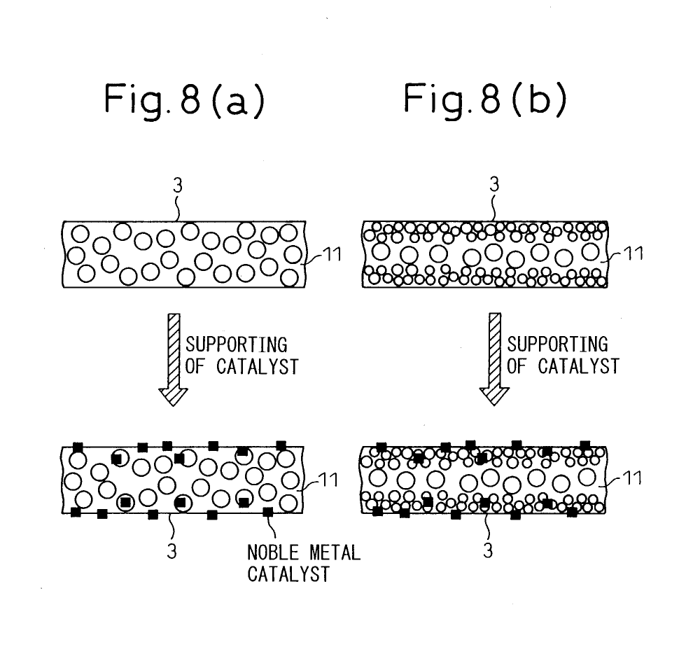

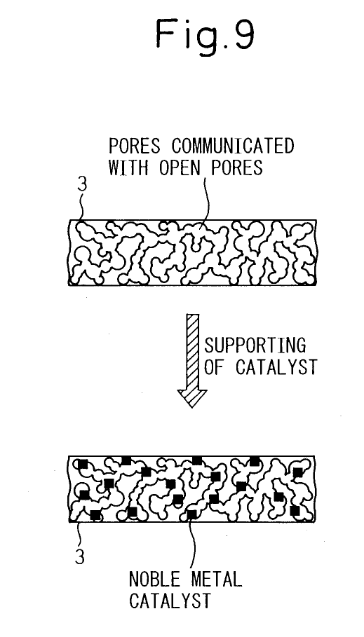

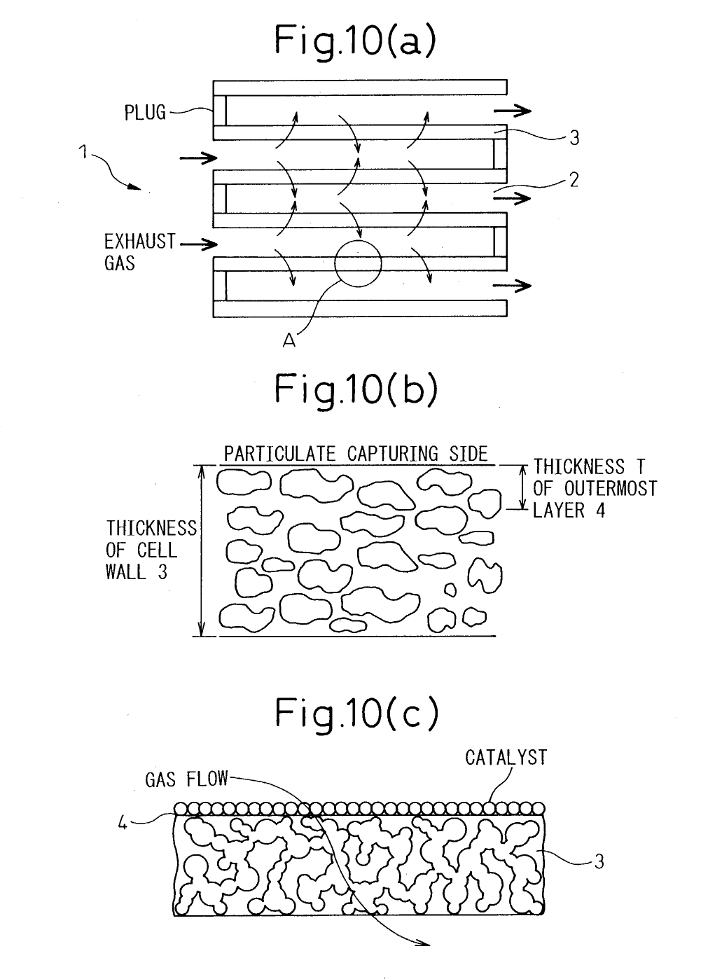

Another example of a method for supporting more than 90% of the catalyst component in the outermost layer 4 of the cell walls will be described below with reference to FIG. 8(a), FIG. 8(b) and FIG. 9. While the pores in the cell walls 3 are filled with the water-repellent material to keep the catalyst component from being deposited in the inner portion in the example described above, such a ceramic carrier 11 may also be used as the formation of pores in the cell walls 3 is controlled as shown in FIG. 8(a) and FIG. 8(b). The cell walls 3 of the ceramic carrier 11 usually have a number of pores formed therein as shown in FIG. 9. These pores are formed as the gas, that is generated when a combustible material such as the binder is burned when sintering the ceramic carrier, escapes from the ceramic material or, in the case of cordierite, after talc has melted away. Since these pores usually communicate with each other, the catalyst component deposits throughout the cell walls 3 when the ceramic carrier is simply immersed in the catalyst solution.

In the ceramic carrier 11 shown in FIG. 8(a), in contrast, the substrate ceramic is made denser so as to form separate pores that do not communicate with each other in the cell walls 3. Specifically, the porosity in the cell walls 3 is made lower than the porosity (35%) of an ordinary ceramic carrier 11, preferably 5% or less. As a lower porosity (water absorptivity) leads to the deposition of less catalyst component, water absorptivity of the inner portion where the catalyst is not required is made lower so as to restrict the infiltration of the catalyst solution to the inner portion of the cell walls 3. With this construction, as the catalyst component is supported only on the surface of the cell walls 3 and in the pores that open in the surface of the cell walls, the catalyst component can be concentrated in the outermost layer 4 of the cell walls 3.

Alternatively, as in a ceramic carrier 11 shown in FIG. 8(b), porosity may be made higher in the outermost layer 4 of the cell walls 3 than in the inner portion, thereby making the water absorptivity higher in the outermost layer 4 so that the catalyst component is more likely to deposit therein. In this case, it is desirable to make the mean pore diameter in the outermost layer 4 smaller than the pore diameter in the inner portion, preferably 80% or less of the pore diameter in the inner portion. As a multitude of small pores formed in the outermost layer 4 increases the surface area of the outermost layer 4, namely the area of supporting the catalyst, the catalyst component can be supported with a higher concentration in the outermost layer 4 of the cell walls 3. In this case, too, it is better to set the porosity in the cell walls 3 to less than 35%, preferably 5% or lower. As the inner pores are formed separate from each other, the catalyst component can be concentrated in the outermost layer 4.

In order to make the ceramic carrier 11 having separate pores that do not communicate with each other as shown in FIG. 8(a), the materials to make the substrate ceramic, for example materials to make cordierite such as talc, kaolin and alumina in case cordierite is used, are prepared in the form of fine particles by crushing the materials in dry or wet process in advance. A material that includes water of crystallization such as kaolin should be calcined at a temperature from 1100 to 1300° C. to remove the water of crystallization in advance, in order to prevent pores from being formed as the water escapes when the preform is sintered. Use of materials in the form of fine particles that do not include water of crystallization enables it to make a dense ceramic body that has separate pores. Particle size of the material is set to about 10 μm or smaller, and preferably 1 μm or smaller.

An example of a manufacturing method will be described below. As the materials to form cordierite, kaolinite (particle size: 0.5 μm), calcined kaolin (particle size: 0.8 μm), talc (particle size: 11 μm) and alumina (particle size: 0.5 μm) were used along with tungsten oxide (particle size: 0.5 μm) added thereto as a compound to supply the element (W) that substitutes a part of the constituent elements, with the mixture being adjusted in proportion around the theoretical composition of cordierite. Proper quantities of a binder, a lubricant and water were added to the mixture, that was formed into honeycomb structure having cell wall thickness of 100 μm, cell density of 400 cpsi and diameter of 50 mm by extrusion molding, and was sintered in air at 1390° C.

The ceramic carrier 11 made as described above was immersed in a catalyst solution, that was prepared by dissolving 0.051 mol/L of chloroplatinic acid and 0.043 mol/L of rhodium chloride in ethanol, for 30 minutes. After drying, the ceramic carrier 11 was sintered at 600° C. in air atmosphere so as to cause metal Pt and Rh deposited and fixed thereon. In order to investigate the condition of supporting the catalyst components on the catalyst body 1 obtained as described above, EPMA analysis was carried out, with results showing that more than 90% of the catalyst component was supported with high concentration in the portion of the cell walls 3 ranging from the surface thereof to a depth of 10 μm.

In order to increase the porosity in the outermost layer 4 as shown in FIG. 8(b), a method may be employed where a preform, that is formed in honeycomb structure from the material of cordierite prepared similarly to the process described above, is dried and coated with a combustible material (resin, foamed material, etc.) on the surface thereof, is burned and leaves pores in the outermost layer 4 when sintered. As an example, a resin (delustering material) of mean particle size 1 μm and a solvent (AE solvent) were mixed and applied to the surface of the dried honeycomb structure that was then sintered in air atmosphere at 1390° C. to obtain the ceramic carrier 11 supporting the catalyst components by a method similar to that described above. EPMA analysts of the catalyst body 1 showed that more than 90% of the catalyst component was supported with high concentration in the portion of the cell walls 3 ranging from the surface thereof to a depth of 3 μm.

The present invention can be applied not only to a catalyst body of flow-through type wherein exhaust gas flows in a direction parallel to the cell walls of the honeycomb but also to a catalyst body of wall flow type wherein the exhaust gas flows through the cell walls of the honeycomb. FIG. 10(a) and FIG. 10(b) schematically show a particulate collecting filter (DPF) for diesel engine, wherein cells 2 are plugged at either end thereof alternately on both sides of the honeycomb, while the cell walls 3 that separate the cells are formed with a high porosity so as to allow the exhaust gas to flow through the cell walls 3. Particulates are captured while passing through the cell walls 3, and are burned and removed by periodically heating. While it is practice to support a combustion catalyst that assists burning of the particulate in the cell walls of the DPF, it may be useless as most of the particulates are captured on and near the surface of the cell walls 3 and therefore the catalyst component supported inside of the cell walls 3 does not contribute to the reaction.

Even in such a case, a sufficient effect can be achieved with less catalyst by depositing more than 90% of the catalyst component in the outermost layer 4 by the method described above with reference to FIG. 3 (a) to FIG. 3(d) and FIG. 4(a) to FIG. 4(d). In this case, too, a sufficient effect can be achieved by making the outermost layer 4 having depth of 30% or less, preferably 25% or less of the thickness of the cell wall 3, namely 30 μm, preferably 25 μm deep from the surface of the cell walls 3. The water-repellent material used for coating the inside of the cell walls 3 when depositing the catalyst is removed during heat treatment, and has no influence on the air permeability of the cell walls 3. As the exhaust gas flows from one side of the cell wall 3 to the other side in the DPF as shown in FIG. 10(c), particulate is collected mostly on the entry side of the wall. In this case, it is not necessary to deposit the catalyst on both sides of the cell walls 3, and the catalyst may be deposited only on the entry side of the cell wall.

According to the present invention, as described above, a quantity of catalyst can be minimized by depositing most of the catalyst components in the outermost layer of the catalyst body. When a catalyst system is constituted from a plurality of catalyst bodies combined, it is not necessary to apply the present invention to all of the catalyst bodies, and any of them may be selected in consideration of the trade-off between cost reduction through decreased quantity of catalyst and simplification of the manufacturing process. If a catalyst for purifying the exhaust gas flowing through the cell walls 3 is to be supported in addition to the combustion catalyst in the DPF described above, for example, it is not necessary to apply the present invention since the purification catalyst is more effective when deposited throughout the cell walls 3 in this case. Thus the present invention may be selectively applied, in accordance to the catalyst component, if a single catalyst body is employed.

What is claimed is:

1. A catalyst body comprising a honeycomb structure carrier having plural cells partitioned with a cell wall, capable of supporting a catalyst component directly on the surface of a substrate ceramic, and the catalyst component supported on the carrier, wherein 90% or more of the catalyst component is supported at an outermost layer of the cell wall.

2. The catalyst body according to claim 1, wherein the outermost layer has a thickness of 30 μm or less from the outermost surface of the cell wall.

3. The catalyst body according to claim 1, wherein the thickness of the outermost layer is 30% or less of the thickness of the cell wall.

4. The catalyst body according to claim 1, wherein a porosity of the outermost layer is larger than a porosity of the inner portion.

5. The catalyst body according to claim 1, wherein the porosity of the inner portion of the cell wall is smaller than 35%.

6. The catalyst body according to claim 1, wherein a mean pore size of the outermost layer is smaller than a mean pore size of the inner portion.

7. The catalyst body according to claim 6, wherein the mean pore size of the outermost layer is 80% or less of the mean pore size of the inner portion.

8. The catalyst body according to claim 1, wherein the carrier is a carrier which has pores or elements capable of supporting the catalyst component directly on the surface of the substrate ceramic.

9. The catalyst body according to claim 8, wherein the pores comprise at least one kind selected from the group consisting of defects in the ceramic crystal lattice, microscopic cracks in the ceramic surface and defects in the elements which constitute the ceramic.

10. The catalyst body according to claim 9, wherein the microscopic cracks measure 100 μm or less in width.

11. The catalyst body according to claim 9, wherein the pores have diameter or width 1000 times the diameter of the catalyst ion to be supported therein or smaller, and the density of pores is 1×10¹¹ /L or higher.

12. The catalyst body according to claim 9, wherein the pores comprise defects formed by substituting one or more elements that constitute the substrate ceramic with a substituting element other than the constituent element, and are capable of supporting the catalyst component directly on the defects.

13. The catalyst body according to claim 8, wherein the element comprises a substituting element introduced by substituting one or more elements that constitute the substrate ceramic with an element other than the constituent element, and is capable of supporting the catalyst component directly on the substituting element.

14. The catalyst body according to claim 13, wherein the catalyst component is supported on the substituting element by chemical bonding.

15. The catalyst body according to claim 13, wherein the substituting element is one or more element having a d or an f orbit in the electron orbits thereof.

16. A method of producing a catalyst body by supporting a catalyst component directly on a honeycomb structure carrier having plural cells partitioned with a cell wall, capable of supporting directly the catalyst component on the surface of a substrate ceramic, said method comprises the steps of immersing the carrier in a water-repellent solution, removing a water-repellent material of an outermost layer of the carrier, and immersing the carrier in a catalyst solution, thereby to support the catalyst component on the outermost layer.
